(19) United States
(12) Patent Application Publication
(10) Pub. No.: US 2024/0406877 A1
(43) Pub. Date: Dec. 5, 2024

(54) METHOD FOR CONTROLLING UPLINK TRANSMISSION AND COMMUNICATION APPARATUS

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 18/292,204

(22) PCT Filed: Jul. 26, 2021
(86) PCT No.: PCT/CN2021/108474

§ 371 Date: Jan. 25, 2024

(51) Int. Cl. H04W 52/14; H04W 52/36

(52) U.S. Cl. CPC H04W 52/146; H04W 52/365

(57) ABSTRACT

A method for controlling uplink transmission, performed by a network device, and the method including transmitting first indication information, wherein the first indication information is used for indicating uplink switch information.

### CROSS REFERENCE TO RELATED APPLICATIONS

The present application is a U.S. National Phase of International Application No. PCT/CN2021/108474, filed on Jul. 26, 2021, the contents of all of which are incorporated herein by reference in their entireties for all purposes.

### BACKGROUND

### Technical Field

The present disclosure relates to the field of communication technology, and in particular, to a method for controlling uplink transmission and an apparatus therefor.

### Description of the Related Art

With the development of communication technology, in order to satisfy higher rate requirements, high-frequency large-scale antenna technology gradually becomes a trend of wireless communication technology development. In a high-frequency band communication process, since a relatively narrow beam is usually used, the communication quality is relatively easily affected by occlusion.

### SUMMARY

In a first aspect, there is provided a method for controlling uplink transmission according to some embodiments of the present disclosure. The method is configured to be performed by a network device, and the method including transmitting first indication information, where the first indication information is used for indicating uplink switch information.

In a second aspect, there is provided another method for controlling uplink transmission according to some embodiments of the present disclosure. The method is configured to be performed by a terminal device, and the method includes receiving first indication information, where the first indication information is used for indicating uplink switch information.

In a third aspect, there is provided a communication apparatus according to an embodiment of the present disclosure. The communication apparatus includes a processor and a memory, and the memory stores a computer program. The processor executes the computer program stored in the memory, so that the communication apparatus performs the method according to the first aspect.

### BRIEF DESCRIPTION OF THE DRAWINGS

In order to illustrate the technical solutions in the embodiments of the present disclosure or in the background more clearly, the drawings that need to be used in the embodiments of the present disclosure or in the background will be described below.

FIG. 1 is a schematic architectural diagram of a communication system according to some embodiments of the present disclosure;

FIG. 2 is a schematic flowchart of a method for controlling uplink transmission according to some embodiments of the present disclosure;

FIG. 3 is a schematic flowchart of a method for controlling uplink transmission according to some embodiments of the present disclosure;

FIG. 4 is a schematic flowchart of a method for controlling uplink transmission according to some embodiments of the present disclosure;

FIG. 5 is a schematic flowchart of a method for controlling uplink transmission according to some embodiments of the present disclosure;

FIG. 6 is a schematic flowchart of a method for controlling uplink transmission according to some embodiments of the present disclosure;

FIG. 7 is a schematic flowchart of a method for controlling uplink transmission according to some embodiments of the present disclosure;

FIG. 8 is a schematic flowchart of a method for controlling uplink transmission according to some embodiments of the present disclosure;

FIG. 9 is a schematic flowchart of a method for controlling uplink transmission according to some embodiments of the present disclosure;

FIG. 10 is a schematic structural diagram of a communication apparatus according to some embodiments of the present disclosure;

FIG. 11 is a schematic structural diagram of a communication apparatus according to some embodiments of the present disclosure;

FIG. 12 is a schematic structural diagram of a chip according to some embodiments of the present disclosure.

### DETAILED DESCRIPTION OF THE PREFERRED EMBODIMENTS

For an uplink beam, in a high-frequency band transmission process, due to the impact of the power of the uplink beam, the occlusion loss cannot be resisted by increasing power. Therefore, how to improve the communication quality of uplink transmission becomes a problem to be solved urgently.

For ease of understanding, the terms involved in the present disclosure are firstly introduced.

### 1. Power Headroom (PH) and Power Headroom Report (PHR).

PH is a difference between the maximum transmission power allowed by the terminal device and the transmission power of the physical uplink shared channel (PUSCH) obtained by current evaluation.

PHR is the process of reporting the power headroom by the terminal device to the network device, which may provide information for power control and scheduling to the network device.

### 2. Maximum Allowed User Equipment Output Power Reduction (P MPR).

Generally, for the maximum output power of the terminal device, due to the impact of factors such as high-order modulation and transmission bandwidth configuration, the maximum output power allows for a reduction, that is, the maximum power reduction.

In order to better understand the method for controlling uplink transmission disclosed in the embodiments of the present disclosure, a communication system, in which the embodiments of the present disclosure are applied, is firstly described below.

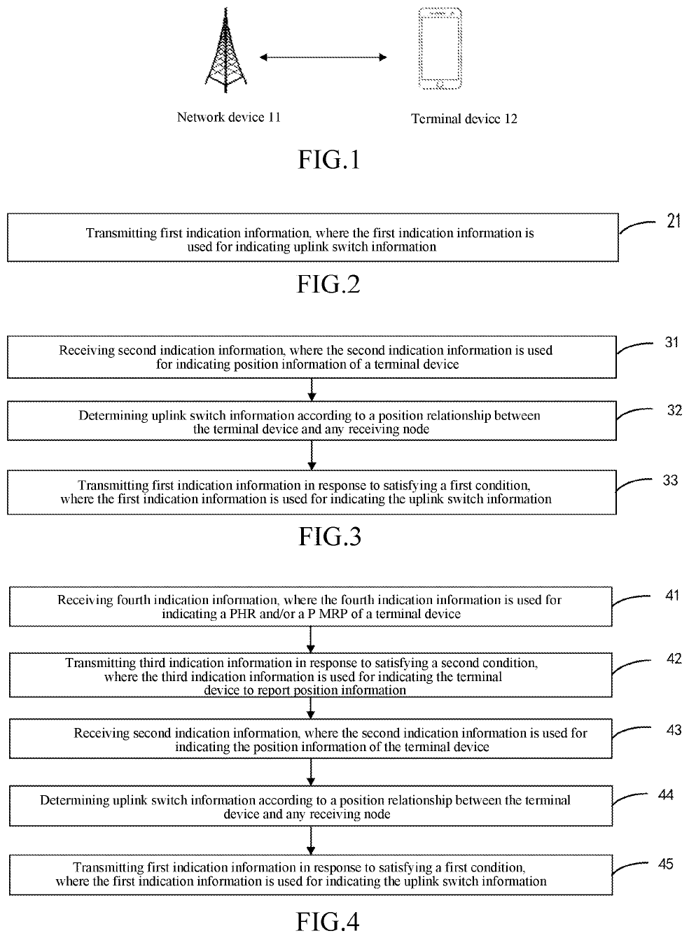

Referring to FIG. 1, FIG. 1 is a schematic architectural diagram of a communication system according to some embodiments of the present disclosure. The communication system may include, but is not limited to, a network device and a terminal device. The number and form of the devices shown in FIG. 1 are used for examples and not to constitute limitations on the embodiments of the present disclosure. In the actual applications, two or more network devices and two or more terminal devices may be included. The communication system shown in FIG. 1 takes that a network device 11 and a terminal device 12 are included as an example.

It should be noted that the technical solutions of the embodiments of the present disclosure may be applied to various communication systems, such as, a long term evolution (LTE) system, a 5th generation (5G) mobile communication system, a 5G new radio (NR) system, or other future novel mobile communication systems, etc.

The network device 11 in the embodiments of the present disclosure is an entity on a network side for transmitting or receiving a signal. For example, the network device 11 may be an evolved NodeB (eNB), a transmission reception point (TRP), a next generation NodeB (gNB) in an NR system, a base station in other future mobile communication systems, or an access node in a wireless fidelity (WiFi) system. The embodiments of the present disclosure do not limit the specific technology and the specific device form used by the network device. The network device provided in the embodiments of the present disclosure may be composed of a central unit (CU) and a distributed unit (DU), where the CU may also be referred to as a control unit. A CU-DU structure may be used to split protocol layers of the network device, such as a base station. The functions of a part of the protocol layers are controlled in a CU set. Functions of the remaining part or all of the protocol layers are distributed in the DU, and the DU is controlled by the CU set.

The terminal device 12 in the embodiments of the present disclosure is an entity on a user side for receiving or transmitting a signal, such as a mobile phone. The terminal device may also be referred to as a terminal, user equipment (UE), a mobile station (MS), a mobile terminal (MT), etc. The terminal device may be an automobile having a communication function, a smart car, a mobile phone, a wearable device, a tablet computer (Pad), a computer with a wireless transceiving function, a terminal device in virtual reality (VR), a terminal device in augmented reality (AR), a wireless terminal device in industrial control, a wireless terminal device in self-driving, a wireless terminal device in remote medical surgery, a wireless terminal device in a smart grid, a wireless terminal devices in transportation safety, a wireless terminal devices in a smart city, a wireless terminal devices in smart home, or the like. The embodiments of the present disclosure do not limit the specific technology and the specific device form used by the terminal device.

It can be understood that the communication system described in the embodiments of the present disclosure is to describe the technical solutions of the embodiments of the present disclosure more clearly, and does not constitute a limitation on the technical solutions provided in the embodiments of the present disclosure Those of ordinary skill in the art may know that, with the evolution of the system architecture and the occurrence of a new service scenario, the technical solutions provided in the embodiments of the present disclosure are also applicable to similar technical problems.

The method and apparatus for controlling uplink transmission provided by the present disclosure will be described in detail below with reference to the accompanying drawings.

Referring to FIG. 2, FIG. 2 is a schematic flowchart of a method for controlling uplink transmission according to some embodiments of the present disclosure, and the method is configured to be performed by a network device. As shown in FIG. 2, the method may include, but is not limited to, the following steps.

In step 21, first indication information is transmitted, where the first indication information is used for indicating uplink switch information.

Generally, in a high-frequency band transmission process, since a relatively narrow beam is used, the uplink beam is easier to be affected by occlusion, so that the quality of communication transmission may be affected.

Thus, in the embodiments of the present disclosure, the network device may transmit the first indication information to the terminal device, so that the terminal device may obtain the uplink switch information, and perform switching on the uplink beam based on the uplink switch information. Therefore, by switching the uplink beam to an uplink beam with no occlusion or with less occlusion for performing uplink transmission, the impact on uplink communication due to occlusion is avoided as much as possible, thus improving the quality of communication transmission.

In some embodiments, the uplink switch information may be a direction of an uplink transmission beam, or may also be an index of an uplink transmission beam, or may also be a direction of an uplink transmission beam and a beam index, etc., which is not limited in the present disclosure.

Among them, the identification or presentation style of the beam index may be agreed upon by a protocol, or may be determined after negotiation between the network device and the terminal device, which is not limited in the present disclosure.

By implementing the embodiments of the present disclosure, the network device may transmit the first indication information to the terminal device, so that the terminal device may obtain the uplink switch information, and perform switching on the uplink beam based on the uplink switch information; therefore, by switching the uplink beam to an uplink beam with no occlusion or with less occlusion for performing uplink transmission, the impact on uplink communication due to occlusion is avoided as much as possible, thus improving the quality of communication transmission.

Referring to FIG. 3, FIG. 3 is a schematic flowchart of a method for controlling uplink transmission according to some embodiments of the present disclosure, and the method is configured to be performed by a network device. As shown in FIG. 3, the method may include, but is not limited to, the following steps.

In step 31, second indication information is received, where the second indication information is used for indicating position information of a terminal device.

In some embodiments, the second indication information may be transmitted by the terminal device in a case that the position changes, or may also be transmitted by the terminal device indicated by the network device, which is not limited in the present disclosure.

In step 32, the uplink switch information is determined according to a position relationship between the terminal device and any receiving node.

Among them, the position information of any receiving node may be preconfigured information used for characterizing the actual setting position of any receiving node, which is not limited in the present disclosure.

For example, the terminal device is located at the position A, and any receiving node b is located at the position B. If the distance between the terminal device and any receiving node b is less than the distance between the terminal device and the network device, the network device may determine that the terminal device may use any receiving node b to perform uplink transmission, and then determine that the corresponding uplink beam index is index1 according to the relative position between any receiving node b and the terminal device. Then, the uplink switch information may be index1.

It should be noted that the above examples are illustrative, and cannot be used as limitations on the position relationship between the terminal device and any receiving node and the uplink switch information, or the like, in the embodiments of the present disclosure.

In step 33, the first indication information is transmitted in response to satisfying a first condition, where the first indication information is used for indicating the uplink switch information.

Among them, the first condition may be agreed upon by a protocol, or may be determined after negotiation between the network device and the terminal device, which is not limited in the present disclosure.

In some embodiments, in a case that the distance between the terminal device and any receiving node is less than the distance between the terminal device and the network device, it may be determined that the first condition is satisfied. Therefore, the network device may transmit the first indication information to the terminal device, so that the terminal device may obtain the uplink switch information.

For example, the terminal device is located at the position A, the receiving node b is located at the position B, the receiving node c is located at the position C, the receiving node d is located at the position D, and the distance between the terminal device and the receiving node dis smaller than the distance between the terminal device and the network device; that is, the first condition is satisfied. Therefore, the network device may transmit the first indication information to the terminal device, so that the terminal device obtains the uplink switch information.

It should be noted that the above examples are illustrative, and cannot be used as limitations on the distance relationship between the terminal device and any receiving node as well as the distance between the terminal device and the network device in the embodiments of the present disclosure.

In some embodiments, in a case that the distance between the terminal device and any receiving node is less than a first threshold, it is determined that the first condition is satisfied.

Among them, the first threshold may be a numerical value agreed upon by a protocol, or may be determined after negotiation between the network device and the terminal device, which is not limited in the present disclosure.

For example, the first threshold is a; the network device determines that the distance between the terminal device and any receiving node is b, and b is less than a; that is, the first condition is satisfied. Therefore, the network device may transmit the first indication information to the terminal device, so that the terminal device may obtain the uplink switch information.

It should be noted that the above examples are illustrative, and cannot be used as a limitation on the manner of determining that the first condition is satisfied in the embodiments of the present disclosure.

In some embodiments, in a case that the distance between the terminal device and any receiving node is minimum and less than the first threshold, it is determined that the first condition is satisfied.

For example, the first threshold is a. The terminal device is located at the position A, the receiving node B is located at the position B, the receiving node c is located at the position C, the receiving node e is located at the position E, the distance between the terminal device and the receiving node a is d1, the distance between the terminal device and the receiving node b is d2, and the distance between the terminal device and the receiving node e is d3. If d1, d2 and d3 are all smaller than the distance between the terminal device and the network device, and the value of d2 is minimum, d2 may be compared with the first threshold a. If d2 is less than the first threshold a, it may be determined that the first condition is satisfied. Therefore, the network device may transmit the first indication information to the terminal device, so that the terminal device obtains the uplink switch information.

It should be noted that the above examples are illustrative, and cannot be used as limitations on the position relationship between the terminal device and any receiving node, the distance between the terminal device and the network device, the first threshold, and the manner of determining that the first condition is satisfied in the embodiments of the present disclosure.

By implementing the embodiments of the present disclosure, the network device may firstly determine the uplink switch information according to the position relationship between the terminal device and any receiving node, and transmit the first indication information when the first condition is satisfied, so that the terminal device may obtain the uplink switch information, and perform switching on the uplink beam based on the uplink switch information. Therefore, by switching the uplink beam to an uplink beam with no occlusion or with less occlusion for performing uplink transmission, the impact on uplink communication due to occlusion is avoided as much as possible, thus improving the quality of communication transmission.

Referring to FIG. 4, FIG. 4 is a schematic flowchart of a method for controlling uplink transmission according to some embodiments of the present disclosure, and the method is configured to be performed by a network device. As shown in FIG. 4, the method may include, but is not limited to, the following steps.

In step 41, fourth indication information is received, where the fourth indication information is used for indicating a PHR and/or a P MRP of the terminal device.

In some embodiments, the fourth indication information may be transmitted by the terminal device in a case that the PH changes, or may also be transmitted by the terminal device indicated by the network device, etc., which is not limited in the present disclosure.

In step 42, third indication information is transmitted in response to satisfying a second condition, where the third indication information is used for indicating the terminal device to report the position information.

In some embodiments, in a case that the PH reported by the terminal device is less than a second threshold, it may be determined that the second condition is satisfied.

Among the, the second threshold may be agreed upon by the protocol, or may be determined after negotiation between the network device and the terminal device, which is not limited in the present disclosure.

For example, the second threshold is 10 decibels (dB), and the PH value reported by the terminal device is 3 dB, which is less than the second threshold; that is, it may be determined that the second condition is satisfied. Therefore, the network device may transmit third indication information to the terminal device to indicate the terminal device to report the position information.

In some embodiments, in a case that the P MRP reported by the terminal device is greater than a third threshold, it may be determined that the second condition is satisfied.

Among them, the third threshold may be agreed upon by a protocol, or may be determined after negotiation between the network device and the terminal device, which is not limited in the present disclosure.

For example, the third threshold is m, the P MRP reported by the terminal device is n, and n is greater than m; that is, the second condition is satisfied. Therefore, the network device may transmit third indication information to the terminal device to indicate the terminal device to report the position information.

It should be noted that the above examples are illustrative, and cannot be used as a limitation on the manner of determining that the second condition is satisfied in the embodiments of the present disclosure.

In step 43, second indication information is received, where the second indication information is used for indicating position information of the terminal device.

In step 44, uplink switch information is determined according to a position relationship between the terminal device and any receiving node.

In step 45, first indication information is transmitted in response to satisfying a first condition, where the first indication information is used for indicating the uplink switch information.

It should be noted that, for the specific contents and implementation manners of steps 43 to 45, reference may be made to the description of other embodiments in the present disclosure, and details are not described here again.

By implementing the embodiments of the present disclosure, the network device may firstly receive the fourth indication information to obtain a PHR and/or a P MRP of the terminal device; then, when the second condition is satisfied, the network device may transmit the third indication information to indicate the terminal device to report the position information; then, the network device may obtain the position information of the terminal device through the received second indication information; then, the network device may determine the uplink switch information according to the position relationship between the terminal device and any receiving node; when the first condition is satisfied, the network device may transmit the first indication information, so that the terminal device may obtain the uplink switch information and perform switching on the uplink beam based on the uplink switch information. Therefore, by switching the uplink beam to an uplink beam with no occlusion or with less occlusion for performing uplink transmission, the impact on uplink communication due to occlusion is avoided as much as possible, thus improving the quality of communication transmission.

Referring to FIG. 5, FIG. 5 is a schematic flowchart of a method for controlling uplink transmission according to some embodiments of the present disclosure, and the method is configured to be performed by a network device. As shown in FIG. 5, the method may include, but is not limited to, the following steps.

In step 51, fourth indication information is received, where the fourth indication information is used for indicating a PHR and/or a P MRP of the terminal device.

In step 52, third indication information is transmitted in response to satisfying a second condition, where the third indication information is used for indicating the terminal device to report position information.

In step 53, second indication information is received, where the second indication information is used for indicating the position information of the terminal device.

It should be noted that, for the specific content and implementation manners of steps 51 to 53, reference may be made to the description of other embodiments in the present disclosure, and details are not described here again.

In step 54, a direction of a receiving beam in a receiving node is received according to the position information of the terminal device.

For example, according to the position information of the terminal device, the network device determines that the terminal device is located in the direction of 30 degrees north by east of the receiving node A; then, the network device may determine that the direction of the receiving beam in the receiving node is 30 degrees north by east; or, the network device may also determine that the direction of the receiving beam in the receiving node is an adjacent direction, etc., which is not limited in the present disclosure.

In step 55, fifth indication information is transmitted to the receiving node, where the fifth indication information is used for indicating the direction of the receiving beam to the receiving node.

For example, after determining the direction of the receiving beam in the receiving node, the network device may transmit the fifth indication information to the receiving node, so that the receiving node may obtain the direction of the receiving beam of the receiving node, and receive the uplink information transmitted by the terminal device in the direction of the receiving beam, etc., which is not limited in the present disclosure.

In step 56, uplink switch information is determined according to a position relationship between the terminal device and the receiving node.

It may be understood that, after the direction of the receiving beam of the receiving node is determined according to the position information of the terminal device, the uplink switch information may be determined based on the position of the receiving node and/or the direction of the corresponding receiving beam.

In step 57, first indication information is transmitted in response to satisfying a first condition, where the first indication information is used for indicating the uplink switch information.

It should be noted that, for the specific contents and implementation manners of steps 56 and 57, reference may be made to description of other embodiments in the present disclosure, and details are not described here again.

It should be noted that, step 54 and step 55 may be performed firstly, then step 56 and step 57 may be performed; or, step 56 and step 57 may be performed firstly, then step 54 and step 55 may be performed; or, step 54, step 55, step 56, and step 57 may also be performed in parallel, etc., which is not limited in the present disclosure.

By implementing the embodiments of the present disclosure, the network device may firstly receive the fourth indication information to obtain a PHR and/or a P MRP of the terminal device; then, when the second condition is satisfied, the network device may transmit the third indication information to indicate the terminal device to report the position information; then, the network device may obtain the position information of the terminal device through the received second indication information; then, the network device may firstly determine the direction of the receiving beam in the receiving node according to the position information of the terminal device, and then transmit the fifth indication information to the receiving node, so that the receiving node may obtain the direction of the receiving beam; and then, the network device may further determine the uplink switch information according to the position relationship between the terminal device and any receiving node, and transmit the first indication information when the first condition is satisfied, so that the terminal device may obtain the uplink switch information and perform switching on the uplink beam based on the uplink switch information. Therefore, by switching the uplink beam to an uplink beam with no occlusion or with less occlusion for performing uplink transmission, the impact on uplink communication due to occlusion is avoided as much as possible, thus improving the quality of communication transmission.

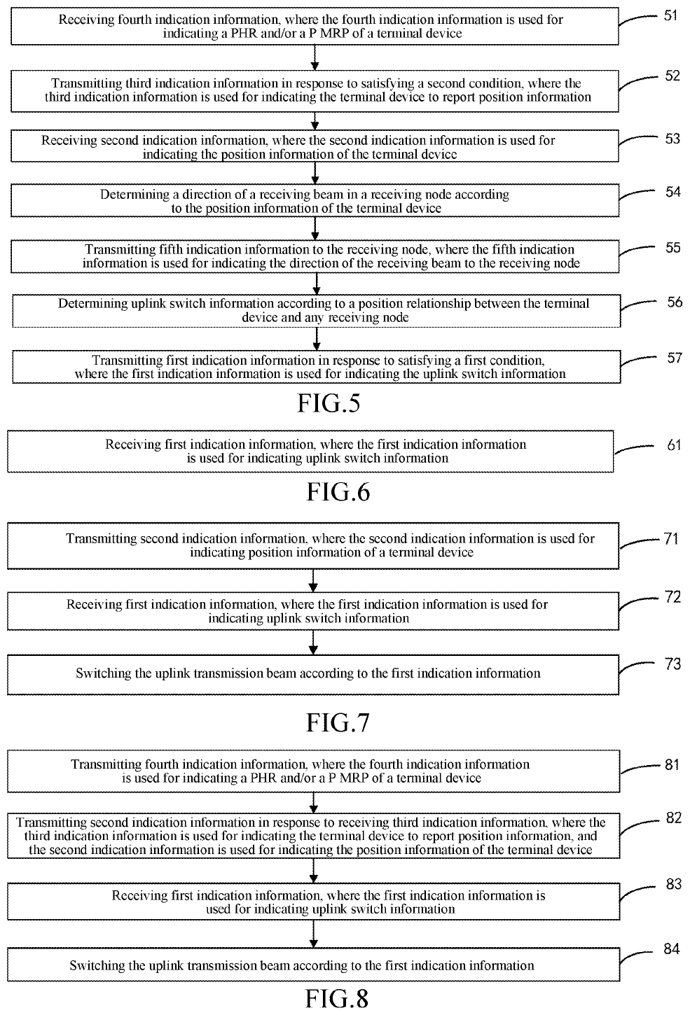

Referring to FIG. 6, FIG. 6 is a schematic flowchart of a method for controlling uplink transmission according to some embodiments of the present disclosure, and the method is configured to be performed by a terminal device. As shown in FIG. 6, the method may include, but is not limited to, the following steps.

In step 61, first indication information is received, where the first indication information is used for indicating uplink switch information.

Generally, in a high-frequency band transmission process, since a relatively narrow beam is used, the uplink beam is easier to be affected by occlusion, so that the quality of communication transmission may be affected.

Thus, in the embodiments of the present disclosure, the terminal device may obtain the uplink switch information according to the received first indication information transmitted by the network device, and perform switching on the uplink beam based on the uplink switch information. Therefore, by switching the uplink beam to an uplink beam with no occlusion or with less occlusion for performing uplink transmission, the impact on uplink communication due to occlusion is avoided as much as possible, thus improving the quality of communication transmission.

In some embodiments, the uplink switch information may be a direction of an uplink transmission beam, or may also be an index of an uplink transmission beam, or may also be a direction of an uplink transmission beam and a beam index, etc., which is not limited in the present disclosure.

By implementing the embodiments of the present disclosure, the terminal device may obtain the uplink switch information according to the received first indication information, and perform switching on the uplink beam based on the uplink switch information. Therefore, by switching the uplink beam to an uplink beam with no occlusion or with less occlusion for performing uplink transmission, the impact on uplink communication due to occlusion is avoided as much as possible, thus improving the quality of communication transmission.

Referring to FIG. 7, FIG. 7 is a schematic flowchart of a method for controlling uplink transmission according to some embodiments of the present disclosure, and the method is configured to be performed by a terminal device. As shown in FIG. 7, the method may include, but is not limited to, the following steps.

In step 71, second indication information is transmitted, where the second indication information is used for indicating position information of the terminal device.

In some embodiments, the terminal device may transmit the second indication information in a case that the position changes, or may also transmit the second indication information according to the indication of the network device, which is not limited in the present disclosure.

In step 72, first indication information is received, where the first indication information is used for indicating uplink switch information.

In some embodiments, the uplink switch information may include at least one of the following: a direction of an uplink transmission beam or a beam index, which is not limited in the present disclosure.

It should be noted that, for the specific content and implementation manner of step 72, reference may be made to the description of other embodiments in the present disclosure, and details are not described here again.

In step 73, the uplink transmission beam is switched according to the first indication information.

For example, according to the first indication information, the terminal device determines that the beam index of the uplink transmission beam is index1, then may switch the uplink transmission beam to index1, and then may perform uplink transmission through index1.

It should be noted that the above examples are illustrative and cannot be used as limitations on the first indication information, the uplink transmission beam, or the like in the embodiments of the present disclosure.

By implementing the embodiments of the present disclosure, the terminal device can transmit the second indication information, so that the network device can obtain the position information of the terminal device; and then, the terminal device can determine the uplink switch information according to the received first indication information, and perform switching on the uplink transmission beam based on the uplink switch information. Therefore, by switching the uplink transmission beam to an uplink beam with no occlusion or with less occlusion for performing uplink transmission, the impact on uplink communication due to occlusion is avoided as much as possible, thus improving the quality of communication transmission.

Referring to FIG. 8, FIG. 8 is a schematic flowchart of a method for controlling uplink transmission according to some embodiments of the present disclosure, and the method is configured to be performed by a terminal device. As shown in FIG. 8, the method may include, but is not limited to, the following steps.

In step 81, fourth indication information is transmitted, where the fourth indication information is used for indicating a PHR and/or a P MRP of the terminal device.

In some embodiments, the fourth indication information may be transmitted by the terminal device in a case that the PH changes, or may also be transmitted by the terminal device indicated by the network device, which is not limited in the present disclosure.

In step 82, second indication information is transmitted in response to receiving third indication information, where the third indication information is used for indicating the terminal device to report position information, and the second indication information is used for indicating the position information of the terminal device.

For example, after receiving the third indication information transmitted by the network device, the terminal device determines that the network device indicates the terminal device to report the position information, and the terminal device may transmit the second indication information to the network device, so that the network device obtains the position information of the terminal device, etc., which is not limited in the present disclosure.

In step 83, first indication information is received, where the first indication information is used for indicating uplink switch information.

In some embodiments, the uplink switch information may include at least one of the following: a direction of an uplink transmission beam or a beam index, which is not limited in the present disclosure.

In step 84, the uplink transmission beam is switched according to the first indication information.

It should be noted that, for the specific contents and implementation manners of steps 83 and 84, reference may be made to description of other embodiments in the present disclosure, and details are not described here again.

By implementing the embodiments of the present disclosure, the terminal device may transmit the fourth indication information to enable the network device to obtain the PHR and/or P MRP of the terminal device, and then may transmit the second indication information to enable the network device to obtain the position information of the terminal device when receiving the third indication information for indicating the terminal device to report the position information, and then may determine the uplink switch information according to the received first indication information and perform switching on the uplink transmission beam based on the uplink switch information. Therefore, by switching the uplink transmission beam to an uplink beam with no occlusion or with less occlusion for performing uplink transmission, the impact on uplink communication due to occlusion is avoided as much as possible, thus improving the quality of communication transmission.

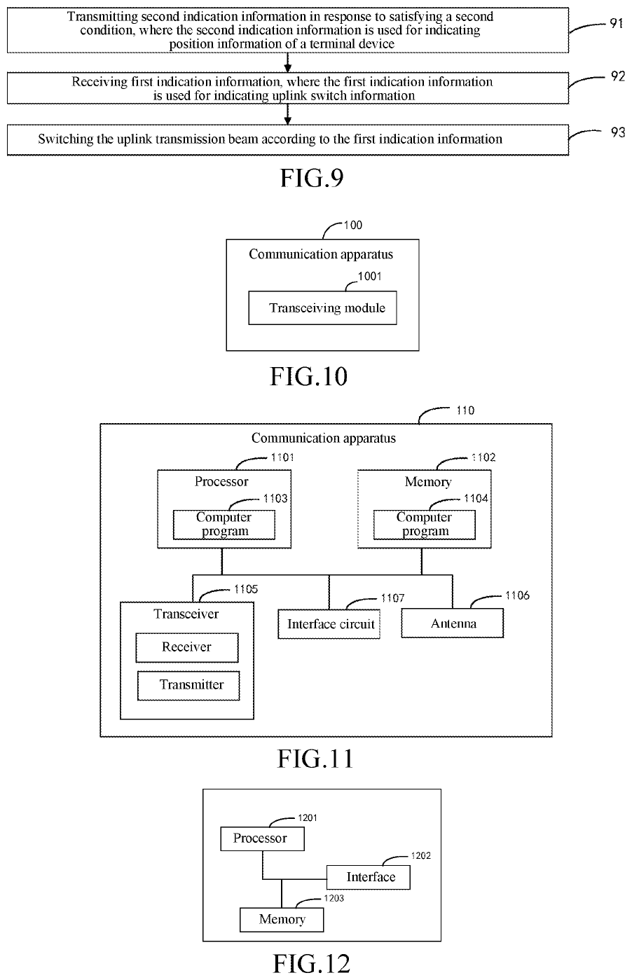

Referring to FIG. 9, FIG. 9 is a schematic flowchart of a method for controlling uplink transmission according to some embodiments of the present disclosure, and the method is configured to be performed by a terminal device. As shown in FIG. 9, the method may include, but is not limited to, the following steps.

In step 91, second indication information is transmitted in response to satisfying a second condition, where the second indication information is used for indicating position information of the terminal device.

In some embodiments, in a case that the PH reported by the terminal device is less than a second threshold, it is determined that the second condition is satisfied.

Among the, the second threshold may be agreed upon by the protocol, or may be determined after negotiation between the network device and the terminal device, which is not limited in the present disclosure.

For example, the second threshold is 11 dB, and the PH value of the terminal device is 3 dB, which is less than the second threshold; that is, the second condition is satisfied. The terminal device may transmit the second indication information to the network device, so that the network device may obtain the position information of the terminal device.

In some embodiments, in a case that the P MRP reported by the terminal device is greater than a third threshold, it may be determined that the second condition is satisfied.

Among them, the third threshold may be agreed upon by a protocol, or may be determined after negotiation between the network device and the terminal device, which is not limited in the present disclosure.

For example, the third threshold is m, the P MRP reported by the terminal device is n, and n is greater than m; that is, the second condition is satisfied. The terminal device may transmit the second indication information to the network device, so that the network device may obtain the position information of the terminal device.

It should be noted that the above examples are illustrative, and cannot be used as a limitation on the manner of determining that the second condition is satisfied in the embodiments of the present disclosure.

In step 92, first indication information is received, where the first indication information is used for indicating uplink switch information.

In some embodiments, the uplink switch information may include at least one of the following: a direction of an uplink transmission beam or a beam index, which is not limited in the present disclosure.

In step 93, the uplink transmission beam is switched according to the first indication information.

It should be noted that, for the specific contents and implementation manners of steps 92 and 93, reference may be made to the description of other embodiments in the present disclosure, and details are not described here again.

By implementing the embodiments of the present disclosure, the terminal device may transmit the second indication information when the second condition is satisfied, so that the network device obtains the position information of the terminal device, and then may determine the uplink switch information according to the received first indication information and perform switching on the uplink transmission beam based on the uplink switch information. Therefore, by switching the uplink transmission beam to an uplink beam with no occlusion or with less occlusion for performing uplink transmission, the impact on uplink communication due to occlusion is avoided as much as possible, thus improving the quality of communication transmission.

In the embodiments provided in the present disclosure, the methods provided by the embodiments of the present disclosure are introduced from the perspective of the network device and the terminal device, respectively. In order to implement the various functions in the methods provided in the embodiments of the present disclosure, the network device and the terminal device may include hardware structures and software modules to implement the above functions in the form of hardware structures, software modules, or hardware structures plus software modules. A certain function in the above various functions may be performed in the form of a hardware structure, a software module, or a hardware structure plus a software module.

Referring to FIG. 100, FIG. 100 is a schematic structural diagram of a communication apparatus 100 according to some embodiments of the present disclosure. The communication apparatus 100 shown in FIG. 10 may include a transceiving module 1001.

The transceiving module 1001 may include a transmitting module and/or a receiving module. The transmitting module is configured to implement a transmitting function, the receiving module is configured to implement a receiving function, and the transceiving module 1001 may implement a transmitting function and/or a receiving function.

It may be understood that the communication apparatus 100 may be a network device, or may be an apparatus in a network device, or may be an apparatus that can be used by matching with a network device.

The communication apparatus 100 is configured on a side of the network device, and includes a transceiving module 1001.

The transceiving module 1001 is configured to transmit first indication information, where the first indication information is used for indicating uplink switch information.

In some embodiments, the transceiving module 1001 is specifically configured to:
transmit the first indication information in response to satisfying a first condition.

In some embodiments, the communication apparatus 100 further includes a processing module configured to:
determine that the first condition is satisfied in response to a distance between a terminal device and any receiving node being less than a distance between the terminal device and the network device;
or,
determine that the first condition is satisfied in response to the distance between the terminal device and any receiving node being less than a first threshold;
or,
determine that the first condition is satisfied in response to the distance between the terminal device and any receiving node being minimum and less than the first threshold.

In some embodiments, the processing module is further configured to:
determine the uplink switch information according to a position relationship between the terminal device and any receiving node.

In some embodiments, the transceiving module 1001 is further configured to receive second indication information, where the second indication information is used for indicating position information of the terminal device.

In some embodiments, the transceiving module 1001 is further configured to:
transmit third indication information in response to satisfying a second condition, where the third indication information is used for indicating the terminal device to report the position information.

In some embodiments, the processing module is further configured to:
determine that the second condition is satisfied in response to a power headroom (PH) reported by the terminal device being less than a second threshold;
or,
determine that the second condition is satisfied in response to a maximum allowed user equipment output power reduction (P MRP) reported by the terminal device being greater than a third threshold.

In some embodiments, the transceiving module 1001 is further configured to:
receive fourth indication information, where the fourth indication information is used for indicating a PHR and/or the P MRP of the terminal device.

In some embodiments, the uplink switch information includes at least one of the following: a direction of an uplink transmission beam or a beam index.

In some embodiments, the processing module is further configured to determine a direction of a receiving beam in a receiving node according to the position information of the terminal device.

The transceiving module 1001 is further configured to transmit fifth indication information to the receiving node, where the fifth indication information is used for indicating a direction of the receiving beam to the receiving node.

According to the communication apparatus provided in the present disclosure, the network device may transmit the first indication information to the terminal device, so that the terminal device may obtain the uplink switch information and perform switching on the uplink beam based on the uplink switch information; therefore, by switching the uplink beam to an uplink beam with no occlusion or with less occlusion for performing uplink transmission, the impact on uplink communication due to occlusion is avoided as much as possible, thus improving the quality of communication transmission.

It may be understood that the communication apparatus 100 may be a terminal device, or may be an apparatus in a terminal device, or may be an apparatus that can be used by matching with a terminal device.

The communication apparatus 100 is configured on a side of a terminal device, and includes a transceiving module 1001.

The transceiving module 1001 is configured to receive first indication information, where the first indication information is used for indicating uplink switch information.

In some embodiments, the uplink switch information includes at least one of the following: a direction of an uplink transmission beam or a beam index.

In some embodiments, the transceiving module 1001 is further configured to:
switch the uplink transmission beam according to the first indication information.

In some embodiments, the transceiving module 1001 is further configured to:
transmit second indication information, where the second indication information is used for indicating position information of the terminal device.

In some embodiments, the transceiving module 1001 is specifically configured to:
in response to receiving third indication information, transmit the second indication information, where the third indication information is used for indicating the terminal device to report the position information;
or,
in response to satisfying a second condition, transmit the second indication information.

In some embodiments, the communication apparatus 100 further includes a processing module configured to:
determine that the second condition is satisfied in response to the power headroom (PH) reported by the terminal device being less than a second threshold;
or,
determine that the second condition is satisfied in response to a maximum allowed user equipment output power reduction (P MRP) reported by the terminal device being greater than a third threshold.

In some embodiments, the transceiving module 1001 is further configured to transmit fourth indication information, where the fourth indication information is used for indicating a PHR and/or the P MRP of the terminal device.

According to the communication apparatus provided in the present disclosure, the terminal device may obtain the uplink switch information according to the received first indication information, and perform switching on the uplink beam based on the uplink switch information; therefore, by switching the uplink beam to an uplink beam with no occlusion or with less occlusion for performing uplink transmission, the impact on uplink communication due to occlusion is avoided as much as possible, thus improving the quality of communication transmission.

Referring to FIG. 11, FIG. 11 is a schematic structural diagram of another communication apparatus 110 according to some embodiments of the present disclosure. The communication apparatus 110 may be a network device, or may be a terminal device, or may be a chip, a chip system, or a processor that supports a network device to implement the above method, or may be a chip, a chip system, or a processor that supports a terminal device to implement the above method. The apparatus may be used to implement the method described in the above method embodiments, and reference may be made to the description in the above method embodiments.

The communication apparatus 110 may include one or more processors 1101, and the processor 1101 may be a general-purpose processor or a dedicated processor. For example, it may be a baseband processor or a central processing unit. The baseband processor may be configured to process a communication protocol and communication data. The central processing unit may be configured to control a communication apparatus (such as a base station, a baseband chip, a terminal device, a terminal device chip, a DU, or a CU), execute a computer program, and process data of the computer program.

In some embodiments, the communication apparatus 110 may further include one or more memories 1102 on which computer programs 1104 may be stored. The processor 1101 executes the computer program 1104, so that the communication apparatus 110 performs the method described in the above method embodiments. In some embodiments, the memory 1102 may further store data. The communication apparatus 110 and the memory 1102 may be separately disposed, or may be integrated together.

In some embodiments, the communication apparatus 110 may further include a transceiver 1105, and an antenna 1106. The transceiver 1105 may be referred to as a transceiver unit, a transceiving machine, or a transceiving circuit, etc., for implementing a transceiving function. The transceiver 1105 may include a receiver and a transmitter. The receiver may be referred to as a receiving machine or a receiving circuit, etc., for implementing a receiving function; and the transmitter may be referred to as a transmitting machine or a transmitting circuit, etc., for implementing a transmitting function.

In some embodiments, the communication apparatus 110 may further include one or more interface circuits 1107 configured to receive code instructions and transmit the code instructions to the processor 1101. The processor 1101 runs the code instructions to enable the communication apparatus 110 to perform the method described in the above method embodiments.

The communication apparatus 110 is a network device. The transceiver 1105 is configured to perform step 21 in FIG. 2, step 31 in FIG. 3, step 33 in FIG. 3, step 41 in FIG. 4, step 42 in FIG. 4, step 43 in FIG. 4, step 45 in FIG. 4, step 51 in FIG. 5, step 52 in FIG. 5, step 53 in FIG. 5, step 55 in FIG. 5, or step 57 in FIG. 5. The processor 1101 is configured to perform step 32 in FIG. 3, step 44 in FIG. 4, step 54 in FIG. 5, or step 56 in FIG. 5.

The communication apparatus 110 is a terminal device. The transceiver 1105 is configured to perform step 61 in FIG. 6, step 71 in FIG. 7, step 72 in FIG. 7, step 73 in FIG. 7, step 81 in FIG. 8, step 82 in FIG. 8, step 83 in FIG. 8, step 84 in FIG. 8, step 91 in FIG. 9, step 92 in FIG. 9, or step 93 in FIG. 9.

In an implementation, the processor 1101 may include a transceiver for implementing receiving and transmitting functions. For example, the transceiver may be a transceiving circuit, an interface, or an interface circuit. The transceiving circuit, the interface, or the interface circuit for implementing the receiving and transmitting functions may be separate or integrated together. The transceiving circuit, the interface, or the interface circuit may be used for reading and writing code/data; or, the transceiving circuit, the interface, or the interface circuit may be used for signal transmission or delivery.

In an implementation, the processor 1101 may store a computer program 1103, and the computer program 1103 runs on the processor 1101 to enable the communication apparatus 110 to perform the method described in the above method embodiments. The computer program 1103 may be cured in the processor 1101; and in this case, the processor 1101 may be implemented by hardware.

In an implementation, the communication apparatus 110 may include a circuit, and the circuit may implement the function of transmitting or receiving or communicating in the above method embodiments. The processor and the transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and the transceiver may also be manufactured using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), Silicon Germanium (SiGe), Gallium Arsenide (GaAs), etc.

The communication apparatus in the above embodiments may be a network device or a terminal device, but the scope of the communication apparatus described in the present disclosure is not limited to this, and the structure of the communication apparatus may not be limited by FIG. 11. The communication apparatus may be a stand-alone device or may be a part of a larger device. For example, the communication apparatus may be:
(1) A stand-alone integrated circuit (IC), a chip, or a chip system or subsystem;
(2) A set having one or more ICs; in some embodiments, the IC set may also include a storage component for storing data and a computer program;
(3) An ASIC, such as a modem;
(4) A module that may be embedded in other devices;
(5) A receiver, a terminal device, an intelligent terminal device, a cellular phone, a wireless device, a handset, a mobile unit, a vehicle-mounted device, a network device, a cloud device, an artificial intelligence device, etc.;
(6) Others, etc.

For the case that the communication apparatus may be a chip or a chip system, reference may be made to the schematic structural diagram of the chip shown in FIG. 12. The chip shown in FIG. 12 includes a processor 1201 and an interface 1202, where the number of the processor 1201 may be one or more, and the number of the interface 1202 may be more than one.

For the case that the chip is used to implement the functions of the network device in the embodiments of the present disclosure:
the interface 1202 is configured to perform step 21 in FIG. 2, step 31 in FIG. 3, step 33 in FIG. 3, step 41 in FIG. 4, step 42 in FIG. 4, step 43 in FIG. 4, step 45 in FIG. 4, step 51 in FIG. 5, step 52 in FIG. 5, step 53 in FIG. 5, step 55 in FIG. 5, or step 57 in FIG. 5.

For the case that the chip is used to implement the functions of the terminal device in the embodiments of the present disclosure:
the interface 1202 is configured to perform step 61 in FIG. 6, step 71 in FIG. 7, step 72 in FIG. 7, step 73 in FIG. 7, step 81 in FIG. 8, step 82 in FIG. 8, step 83 in FIG. 8, step 84 in FIG. 8, step 91 in FIG. 9, step 92 in FIG. 9, or step 93 in FIG. 9.

In some embodiments, the chip further includes a memory 1203, and the memory 1203 is configured to store necessary computer programs and data.

Those skilled in the art may also understand that the various illustrative logical blocks and steps listed in the embodiments of the present disclosure may be implemented by electronic hardware, computer software, or a combination of the two. Whether such a function is implemented by hardware or software depends on specific applications and the design requirements of the entire system. Those skilled in the art may implement the functions by using various methods for each specific application, but it should not be understood as that the implementation goes beyond the scope of protection of the embodiments of the present disclosure.

There is further provided a system for controlling uplink transmission according to some embodiments of the present disclosure. The system includes a communication apparatus serving as a terminal device and a communication apparatus serving as a network device in the above embodiment of FIG. 10; or, the system includes a communication apparatus serving as a terminal device and a communication apparatus serving as a network device in the above embodiment of FIG. 11.

The present disclosure further provides a computer-readable storage medium. The computer-readable storage medium stores an instruction on it. When the instruction is executed by a computer, the functions of any one of the above method embodiments are implemented.

The present disclosure further provides a computer program product. When the computer program product is executed by a computer, the functions of any one of the above method embodiments are implemented.

According to embodiments of the present disclosure, there is provided a method for controlling uplink transmission and an apparatus therefor, which can be applied in the field of communication technology.

In a first aspect, there is provided a method for controlling uplink transmission according to some embodiments of the present disclosure. The method is configured to be performed by a network device, and the method including: transmitting first indication information, where the first indication information is used for indicating uplink switch information.

In this solution, the network device may transmit the first indication information to the terminal device, so that the terminal device may obtain the uplink switch information and perform switching on the uplink beam based on the uplink switch information; therefore, by switching the uplink beam to an uplink beam with no occlusion or with less occlusion for performing uplink transmission, the impact on uplink communication due to occlusion is avoided as much as possible, thus improving the quality of communication transmission.

In some embodiments, transmitting the first indication information includes:
transmitting the first indication information in response to satisfying a first condition.

In some embodiments, the method further includes:
determining that the first condition is satisfied in response to a distance between a terminal device and any receiving node being less than a distance between the terminal device and the network device;
or,
determining that the first condition is satisfied in response to the distance between the terminal device and any receiving node being less than a first threshold;
or,
determining that the first condition is satisfied in response to the distance between the terminal device and any receiving node being minimum and less than the first threshold.

In some embodiments, the method further includes:
determining the uplink switch information according to a position relationship between the terminal device and the any receiving node.

In some embodiments, the method further includes receiving second indication information, where the second indication information is used for indicating position information of the terminal device.

In some embodiments, the method further includes transmitting third indication information in response to satisfying a second condition, where the third indication information is used for indicating the terminal device to report the position information.

In some embodiments, the method further includes:
determining that the second condition is satisfied in response to a power headroom (PH) reported by the terminal device being less than a second threshold;
or,
determining that the second condition is satisfied in response to a maximum allowed user equipment output power reduction (P MRP) reported by the terminal device being greater than a third threshold.

In some embodiments, the method further includes receiving fourth indication information, where the fourth indication information is used for indicating a PHR and/or the P MRP of the terminal device.

In some embodiments, the uplink switch information includes at least one of following: a direction of an uplink transmission beam or a beam index.

In some embodiments, the method further includes determining a direction of a receiving beam in a receiving node according to the position information of the terminal device, and transmitting fifth indication information to the receiving node, where the fifth indication information is used for indicating the direction of the receiving beam to the receiving node.

In a second aspect, there is provided another method for controlling uplink transmission according to some embodiments of the present disclosure. The method is configured to be performed by a terminal device, and the method includes: receiving first indication information, where the first indication information is used for indicating uplink switch information.

In this solution, the terminal device may obtain uplink switch information according to the received first indication information, and perform switching on the uplink beam based on the uplink switch information; therefore, by switching the uplink beam to an uplink beam with no occlusion or with less occlusion for performing uplink transmission, the impact on uplink communication due to occlusion is avoided as much as possible, thus improving the quality of communication transmission.

In some embodiments, the uplink switch information includes at least one of following: a direction of an uplink transmission beam or a beam index.

In some embodiments, the method further includes switching the uplink transmission beam according to the first indication information.

In some embodiments, the method further includes transmitting second indication information, where the second indication information is used for indicating position information of the terminal device.

In some embodiments, transmitting the second indication information includes:
transmitting the second indication information in response to receiving third indication information, where the third indication information is used for indicating the terminal device to report the position information;
or,
transmitting the second indication information in response to satisfying a second condition.

In some embodiments, the method further includes:
determining that the second condition is satisfied in response to a power headroom (PH) reported by the terminal device being less than a second threshold;
or,
determining that the second condition is satisfied in response to a maximum allowed user equipment output power reduction (P MRP) reported by the terminal device being greater than a third threshold.

In some embodiments, the method further includes transmitting fourth indication information, where the fourth indication information is used for indicating a PHR and/or the P MRP of the terminal device.

In a third aspect, there is provided a communication apparatus according to some embodiments of the present disclosure. The apparatus is configured on a side of a network device, and the apparatus includes a transceiving module configured to transmit first indication information, where the first indication information is used for indicating uplink switch information.

In this solution, the network device may transmit the first indication information to the terminal device, so that the terminal device may obtain the uplink switch information and perform switching on the uplink beam based on the uplink switch information; therefore, by switching the uplink beam to an uplink beam with no occlusion or with less occlusion for performing uplink transmission, the impact on uplink communication due to occlusion is avoided as much as possible, thus improving the quality of communication transmission.

In some embodiments, the transceiving module is specifically configured to:
transmit the first indication information in response to satisfying a first condition.

In some embodiments, the communication apparatus further includes a processing module configured to:
determine that the first condition is satisfied in response to a distance between a terminal device and any receiving node being less than a distance between the terminal device and the network device;
or,
determine that the first condition is satisfied in response to the distance between the terminal device and any receiving node being less than a first threshold;
or,
determine that the first condition is satisfied in response to the distance between the terminal device and any receiving node being minimum and less than the first threshold.

In some embodiments, the processing module is further configured to determine the uplink switch information according to a position relationship between the terminal device and any receiving node.

In some embodiments, the transceiving module is further configured to receive second indication information, where the second indication information is used for indicating position information of the terminal device.

In some embodiments, the transceiving module is further configured to transmit third indication information in response to satisfying a second condition, where the third indication information is used for indicating the terminal device to report the position information.

In some embodiments, the processing module is further configured to:
determine that the second condition is satisfied in response to a power headroom (PH) reported by the terminal device being less than a second threshold;
or,
determine that the second condition is satisfied in response to a maximum allowed user equipment output power reduction (P MRP) reported by the terminal device being greater than a third threshold.

In some embodiments, the transceiving module is further configured to:
receive fourth indication information, where the fourth indication information is used for indicating a PHR and/or the P MRP of the terminal device.

In some embodiments, the uplink switch information includes at least one of the following a direction of an uplink transmission beam or a beam index.

In some embodiments, the processing module is further configured to:
determine a direction of a receiving beam in a receiving node according to the position information of the terminal device.

The transceiving module is further configured to transmit fifth indication information to the receiving node, where the fifth indication information is used for indicating a direction of the receiving beam to the receiving node.

In a fourth aspect, there is provided another communication apparatus according to some embodiments of the present disclosure. The apparatus is configured on a side of a terminal device, and the apparatus includes a transceiving module configured to receive first indication information, where the first indication information is used for indicating uplink switch information.

In this solution, the terminal device may obtain uplink switch information according to the received first indication information, and perform switching on the uplink beam based on the uplink switch information; therefore, by switching the uplink beam to an uplink beam with no occlusion or with less occlusion for performing uplink transmission, the impact on uplink communication due to occlusion is avoided as much as possible, thus improving the quality of communication transmission.

In some embodiments, the uplink switch information includes at least one of the following: a direction of an uplink transmission beam or a beam index.

In some embodiments, the transceiving module is further configured to switch the uplink transmission beam according to the first indication information.

In some embodiments, the transceiving module is further configured to transmit second indication information, where the second indication information is used for indicating position information of the terminal device.

In some embodiments, the transceiving module is specifically configured to:
in response to receiving third indication information, transmit the second indication information, where the third indication information is used for indicating the terminal device to report the position information;
or,
in response to satisfying a second condition, transmit the second indication information.

In some embodiments, the communication apparatus further includes a processing module configured to:
determine that the second condition is satisfied in response to the power headroom (PH) reported by the terminal device being less than a second threshold;
or,
determine that the second condition is satisfied in response to a maximum allowed user equipment output power reduction (P MRP) reported by the terminal device being greater than a third threshold.

In some embodiments, the transceiving module is further configured to:
transmit fourth indication information, where the fourth indication information is used for indicating a PHR and/or the P MRP of the terminal device.

In a fifth aspect, there is provided a communication apparatus according to some embodiments of the present disclosure. The communication apparatus includes a processor, and when the processor invokes a computer program in a memory, the method according to the first aspect is performed.

In a sixth aspect, there is provided a communication apparatus according to some embodiments of the present disclosure. The communication apparatus includes a processor, and when the processor invokes a computer program in a memory, the method according to the second aspect is performed.

In a seventh aspect, there is provided a communication apparatus according to some embodiments of the present disclosure. The communication apparatus includes a processor and a memory, and the memory stores a computer program. The processor executes the computer program stored in the memory, so that the communication apparatus performs the method according to the first aspect.

In an eighth aspect, there is provided a communication apparatus according to some embodiments of the present disclosure. The communication apparatus includes a processor and a memory, and the memory stores a computer program. The processor executes the computer program stored in the memory, so that the communication apparatus performs the method according to the second aspect.

In a ninth aspect, there is provided a communication apparatus according to some embodiments of the present disclosure. The communication apparatus includes a processor and an interface circuit. The interface circuit is configured to receive a code instruction and transmit the code instruction to the processor. The processor is configured to run the code instruction to enable the apparatus to perform the method according to the first aspect.

In a tenth aspect, there is provided a communication apparatus according to some embodiments of the present disclosure. The communication apparatus includes a processor and an interface circuit. The interface circuit is configured to receive a code instruction and transmit the code instruction to the processor. The processor is configured to run the code instruction to enable the apparatus to perform the method according to the second aspect.

In an eleventh aspect, there is provided a system for controlling uplink transmission according to some embodiments of the present disclosure. The system includes the communication apparatus according to the third aspect and the communication apparatus according to the fourth aspect; or, the system includes the communication apparatus according to the fifth aspect and the communication apparatus according to the sixth aspect; or, the system includes the communication apparatus according to the seventh aspect and the communication apparatus according to the eighth aspect; or, the system includes the communication apparatus according to the ninth aspect and the communication apparatus according to the tenth aspect.

In a twelfth aspect, there is provided a computer-readable storage medium according to some embodiments of the present disclosure. The computer-readable storage medium is configured to store an instruction used by the network device; when the instruction is executed, the network device is enabled to perform the method according to the first aspect.

In a thirteenth aspect, there is provided a computer-readable storage medium according to some embodiments of the present disclosure. The computer-readable storage medium is configured to store an instruction used by the terminal device; when the instruction is executed, the terminal device is enabled to perform the method according to the second aspect.

In a fourteenth aspect, there is further provided a computer program product including a computer program according to the present disclosure. When the computer program product runs on a computer, the computer is enabled to perform the method described according to the first aspect.

In a fifteenth aspect, there is further provided a computer program product including a computer program according to the present disclosure. When the computer program product runs on a computer, the computer is enabled to perform the method described according to the second aspect.

In a sixteenth aspect, there is provided a chip system according to the present disclosure. The chip system includes at least one processor and an interface, for supporting a network device to implement the functions involved in the first aspect, for example, to determine or process at least one of data or information involved in the above method. In a possible design, the chip system further includes a memory, and the memory is configured to store a computer program and data necessary for the network device. The chip system may be composed of a chip, or may include a chip and other discrete devices.

In a seventeenth aspect, there is provided a chip system according to the present disclosure. The chip system includes at least one processor and an interface, for supporting a terminal device to implement the functions involved in the second aspect, for example, to determine or process at least one of data or information involved in the above method. In a possible design, the chip system further includes a memory, and the memory is configured to store a computer program and data necessary for the terminal device. The chip system may be composed of a chip, or may include a chip and other discrete devices.

In an eighteenth aspect, there is provided a computer program according to the present disclosure; when the computer program runs on a computer, the computer is enabled to perform the method according to the first aspect.

In a nineteenth aspect, there is provided a computer program according to the present disclosure; when the computer program runs on a computer, the computer is enabled to perform the method according to the second aspect.

In the above embodiments, they may be all or partially implemented by software, hardware, firmware, or any combination of them. When implemented using software, they may be all or partially implemented in the form of a computer program product. The computer program product includes one or more computer programs. When the computer program is loaded and executed on a computer, the processes or functions according to the embodiments of the present disclosure are all or partially generated. The computer may be a general-purpose computer, a dedicated computer, a computer network, or other programmable apparatus. The computer program may be stored in a non-transitory computer-readable storage medium or transmitted from a computer-readable storage medium to another computer-readable storage medium. For example, the computer program may be transmitted from a website site, a computer, a server, or a data center to another website site, another computer, another server, or another data center in a wired manner (for example, coaxial cable, optical fiber, digital subscriber line (DSL)) or a wireless manner (for example, infrared, wireless, microwave, etc.). The computer-readable storage medium may be any usable medium accessible by a computer, or a data storage device such as a server or a data center integrated with one or more usable medium. The usable medium may be a magnetic medium (for example, a floppy disk, a hard disk, or a magnetic tape), an optical medium (for example, a high-density digital video disc (DVD)), or a semiconductor medium (for example, a solid-stated disk (SSD)), etc.

Those of ordinary skills in the art may understand that the first, second and other numerical symbols involved in the present disclosure are for distinguishing for the sake of convenience in description, and are not used to limit the scope of the embodiments of the present disclosure, and also represent the sequence.

At least one in the present disclosure may also be described as one or more, and more than one may be two, three, four or more, which is not limited in the present disclosure. In the embodiments of the present disclosure, for a kind of technical features, the technical features in this kind of technical features are distinguished by “first”, “second”, “third”, “A”, “B”, “C”, “D”, etc. The technical features described in “first”, “second”, “third”, “A”, “B”, “C” and “D” have no sequential order or size order.

The corresponding relationship shown in each table in the present disclosure may be configured, or may be predefined. The value of the information in each table is an example, and may be configured as other values, which is not limited in the present disclosure. When the corresponding relationship between the information and each parameter is configured, there is no need to configure all corresponding relationships shown in each table. For example, in the table in the present disclosure, the corresponding relationships shown in certain rows may also not be configured. For another example, appropriate deformation adjustment may be performed based on the above table, such as, splitting, merging, or the like. The name of the parameter shown in the title of each table may also use other names that may be understood by the communication apparatus, and the value or the representation manner of the parameter may also be other values or representation manners that may be understood by the communication apparatus. When the above tables are implemented, other data structures may also be used; for example, an array, a queue, a container, a stack, a linear table, a pointer, a linked list, a tree, a graph, a structure, a class, a stack, a hash table, or a hash table may be used.

Predefining in the present disclosure may be understood as defining, pre-defining, storing, pre-storing, pre-negotiating, pre-configuring, curing, or pre-firing.

Those of ordinary skills in the art may be aware that units and algorithm steps in the examples described in connection with the embodiments disclosed here can be implemented by electronic hardware, or a combination of computer software and electronic hardware. Whether the functions are performed by hardware or software depends on specific applications and design constraint conditions of the technical solutions. Those skilled in the art may use different methods to implement the described functions for each specific application, but it should not be considered that the implementation goes beyond the scope of the present disclosure.

It may be clearly understood by those skilled in the art that, for the convenience and brevity of description, the specific working process of the described system, apparatus, and units may refer to the corresponding process in the above method embodiments, and details are not described here again.

The above description is a specific implementation of the present disclosure, but the scope of protection of the present disclosure is not limited to this. Any of those skilled in the art familiar with the art may easily conceive of change or replacement within the technical scope disclosed in the present disclosure, which should be covered within the scope of protection of the present disclosure. Therefore, the protection scope of the present disclosure shall be subject to the protection scope of the claims.

1. A method for controlling uplink transmission, performed by a network device, and the method comprising:
transmitting first indication information, wherein the first indication information is used for indicating uplink switch information.

2. The method according to claim 1, wherein transmitting the first indication information comprises:
transmitting the first indication information in response to satisfying a first condition.

3. The method according to claim 2, further comprising at least one of:
determining that the first condition is satisfied in response to a distance between a terminal device and a receiving node being less than a distance between the terminal device and the network device;
determining that the first condition is satisfied in response to the distance between the terminal device and the receiving node being less than a first threshold; or
determining that the first condition is satisfied in response to the distance between the terminal device and the receiving node being minimum and less than the first threshold.

4. The method according to claim 3, further comprising at least one of:
determining the uplink switch information according to a position relationship between the terminal device and the receiving node; or
receiving second indication information, wherein the second indication information is used for indicating position information of the terminal device.

5. (canceled)

6. The method according to claim 4, further comprising:
transmitting third indication information in response to satisfying a second condition, wherein the third indication information is used for indicating the terminal device to report the position information.

7. The method according to claim 6, further comprising at least one of:
determining that the second condition is satisfied in response to a power headroom (PH) reported by the terminal device being less than a second threshold; or
determining that the second condition is satisfied in response to a maximum allowed user equipment output power reduction (P MRP) reported by the terminal device being greater than a third threshold.

8. The method according to claim 7, further comprising:
receiving fourth indication information, wherein the fourth indication information is used for indicating a PHR and/or the P MRP of the terminal device.

9. The method according to claim 1, wherein the uplink switch information includes at least one of following:
a direction of an uplink transmission beam or a beam index.

10. The method according to claim 1, further comprising:
determining a direction of a receiving beam in a receiving node according to the position information of the terminal device; and
transmitting fifth indication information to the receiving node, wherein the fifth indication information is used for indicating the direction of the receiving beam to the receiving node.

11. A method for controlling uplink transmission, performed by a terminal device, and the method comprising:
receiving first indication information, wherein the first indication information is used for indicating uplink switch information.

12. The method according to claim 11, wherein the uplink switch information comprises at least one of following:
a direction of an uplink transmission beam or a beam index.

13. The method according to claim 12, further comprising:
switching the uplink transmission beam according to the first indication information.

14. The method according to claim 11, further comprising:
transmitting second indication information, wherein the second indication information is used for indicating position information of the terminal device.

15. The method according to claim 14, wherein transmitting the second indication information comprises at least one of:
transmitting the second indication information in response to receiving third indication information, wherein the third indication information is used for indicating the terminal device to report the position information; or
transmitting the second indication information in response to satisfying a second condition.

16. The method according to claim 15, further comprising at least one of:
determining that the second condition is satisfied in response to a power headroom (PH) reported by the terminal device being less than a second threshold; or
determining that the second condition is satisfied in response to a maximum allowed user equipment output power reduction (P MRP) reported by the terminal device being greater than a third threshold.

17. The method according to claim 16, further comprising:
transmitting fourth indication information, wherein the fourth indication information is used for indicating a PHR and/or the P MRP of the terminal device.

18-19. (canceled)

20. A communication apparatus, comprising a processor and a memory, wherein a computer program is stored in the memory, and the processor executes the computer program stored in the memory to enable the communication apparatus to perform a method for controlling uplink transmission, and the method comprises:
transmitting first indication information, wherein the first indication information is used for indicating uplink switch information.

21. A communication apparatus, comprising a processor and a memory, wherein a computer program is stored in the memory, and the processor executes the computer program stored in the memory to enable the communication apparatus to perform the method according to claim 11.

22-23. (canceled)

24. A computer-readable storage medium, configured for storing an instruction, wherein the method according to claim 1 is enabled to be implemented when the instruction is executed.

25. A computer-readable storage medium, configured for storing an instruction, wherein the method according to claim 11 is enabled to be implemented when the instruction is executed.
